(19) United States
(12) Patent Application Publication
(10) Pub. No.: US 2025/0225649 A1
(43) Pub. Date: Jul. 10, 2025

(54) METHOD AND APPARATUS WITH ANOMALY DETECTION USING ANOMALY MAP

(71) Applicant: Samsung Electronics Co., Ltd., Suwon-si (KR)

(72) Inventors: Saehyun AHN, Suwon-si (KR); Wissam BADDAR, Suwon-si (KR); Huijin LEE, Suwon-si (KR)

(73) Assignee: Samsung Electronics Co., Ltd., Suwon-si (KR)

(21) Appl. No.: 19/009,265

(22) Filed: Jan. 3, 2025

(30) Foreign Application Priority Data
Jan. 4, 2024 (KR) 10-2024-0001790

(51) Int. Cl. G06T 7/00; G06V 10/80

(52) U.S. Cl. CPC G06T 7/001; G06V 10/806; G06T 2207/30148

(57) ABSTRACT

A method and an apparatus are provided to detect an anomaly in an image through generating a first anomaly map related to pixel-level features of the input image and a second anomaly map related to structural features of the input image based on the input image and a non-defect image similar to the input image, and merging the first anomaly map and the second anomaly map to generate a multi-anomaly map.

### CROSS-REFERENCE TO RELATED APPLICATION

This application claims priority to and the benefit of Korean Patent Application No. 10-2024-0001790 filed in the Korean Intellectual Property Office on Jan. 4, 2024, the entire contents of which are incorporated herein by reference.

### BACKGROUND

### 1. Field

This disclosure relates to a method and a device an anomaly map and anomaly detection.

### 2. Description of Related Art

An anomaly detection system learns characteristics of training images assumed to be normal samples and can then detect regions of an input image that have characteristics different from that of the learned training images. For example, an anomaly detection system may extract a characteristic from an input image and use a distance between the extracted characteristic of the input image and the characteristic of the normal data to determine whether the input image is anomaly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for detecting an anomaly in an input image is performed by one or more processors and includes: generating a first anomaly map of pixel-level features of an input image and a second anomaly map of structural features of the input image, the generating based on the input image and based on a first non-defect image corresponding to the input image; generating a multi-anomaly map by merging the first anomaly map and the second anomaly map; and detecting the anomaly in the input image based on the multi-anomaly map.

The method may further include: generating the first non-defect image from the input image by using a generative artificial intelligence (AI) model.

The method may further include: performing a preprocessing on the input image to generate a preprocessed input image; and generating a second non-defect image similar to the preprocessed input image by using a generative artificial intelligence (AI) model.

The generating the first anomaly map of pixel-level features of the input image and the second anomaly map of structural features of the input image based on the input image and based on the non-defect image corresponding to the input image may include generating the first anomaly map and the second anomaly map based on the preprocessed input image and the second non-defect image corresponding to the preprocessed input image.

The generating the first anomaly map of pixel-level features of the input image and the second anomaly map of structural features of the input image based on the input image and the non-defect image corresponding to the input image may include generating the first anomaly map based on a difference between a first pixel of the input image and a second pixel of the non-defect image, wherein the second pixel corresponds to the first pixel.

The generating the first anomaly map of the pixel-level features of the input image and the second anomaly map of the structural features of the input image based on the input image and the non-defect image corresponding to the input image may include calculating a patch similarity between a patch of a predetermined size in the input image and a corresponding patch in the non-defect image; and generating the second anomaly map based on the patch similarity.

The patch similarity may be calculated by performing padding on the input image and the non-defect image and moving the patch by a stride of a predetermined spacing.

The merging the first anomaly map and the second anomaly map may include multiplying pixel values of pixels of the first anomaly map with pixel values of respectively corresponding pixels in the second anomaly map.

The detecting the anomaly in the input image based on the multi-anomaly map may include detecting a non-defect region and/or an abnormal region in the input image based on a condition related to pixel values of the multi-anomaly map.

The method may further include: determining a defective patch within the input image by using the multi-anomaly map in response to the anomaly being detected in the input image; and transmitting information about the defective patch to a defect classification system.

In another general aspect, an apparatus for detecting an anomaly in an image includes: one or more processors and a memory, wherein the memory stores instructions configured to cause the one or more processors to perform a process including: generating a first anomaly map related to pixel-level features of the input image based on the input image and a non-defect image corresponding to the input image; generating a second anomaly map related to structural features of the input image based on the input image and the non-defect image; generating a multi-anomaly map by merging the first anomaly map and the second anomaly map; and detecting the anomaly in the input image based on the multi-anomaly map.

The process may further include: generating a preprocessed input image by preprocessing on the input image; and generating the non-defect image similar to the preprocessed input image by using a generative artificial intelligence (AI) model.

The generating the first anomaly map related to the pixel-level features of the input image may include generating the first anomaly map based on differences between first pixels of the input image and second pixels of the non-defect image, wherein positions of respective second pixels corresponds to the positions of respective first pixels.

The generating the second anomaly map related to the structural features of the input image may include: calculating patch similarity between the input image and the non-defect image for a patch having a predetermined size in the input image; and generating the second anomaly map based on the patch similarity between the input image and the non-defect image.

The calculating the patch similarity between the input image and the non-defect image may include performing padding on the input image and the non-defect image; and calculating the patch similarity by moving the patch by a stride of a predetermined spacing.

The generating the multi-anomaly map by merging the first anomaly map and the second anomaly map may include generating the multi-anomaly map by multiplying pixel values of corresponding pixels between the first anomaly map and the second anomaly map.

In another general aspect, a system for detecting a defect in a semiconductor manufacturing process includes: an anomaly detection device configured to generate a multi-anomaly map based on an unlabeled input image transmitted from inspection equipment of the semiconductor manufacturing process and a non-defect image similar to the input image, and detect an anomaly in the input image based on the multi-anomaly map; and a defect classification device configured to determine a type of the defect corresponding to the anomaly of the input image.

When detecting the anomaly in the input image based on the multi-anomaly map, the anomaly detection device may be further configured to use the multi-anomaly map to determine a patch including the anomaly and transmit information about the patch to the defect classification device.

When generating the multi-anomaly map based on the input image and the non-defect image, the anomaly detection device may be further configured to merge a first anomaly map related to pixel-level features of the input image and a second anomaly map related to structural features of the input image to generate the multi-anomaly map.

The anomaly detection device may be further configured to generate the first anomaly map based on differences between first pixels of the input image and second pixels of the non-defect image and generate the second anomaly map based on similarity of patches between the input image and the non-defect image.

Other features and aspects will be apparent from the following detailed description, the drawings, and the claims.

### BRIEF DESCRIPTION OF THE DRAWINGS

FIG. 1 illustrates an apparatus for detecting an anomaly in an image according to one or more embodiments.

FIG. 2 illustrates a method for detecting an anomaly in an image according to one or more embodiments.

FIG. 3 illustrates a normal image and a multi-anomaly map of the normal image according to one or more embodiments.

FIG. 4 illustrates an abnormal image and a multi-anomaly map of the abnormal image according to one or more embodiments.

FIG. 5 illustrates an apparatus for detecting an anomaly in an image according to one or more embodiments.

FIG. 6 illustrates a system for detecting defect in a semiconductor manufacturing process according to one or more embodiments.

FIG. 7 illustrates an example of a generative artificial intelligence (AI) model structure according to one or more embodiments.

FIG. 8 illustrates a neural network according to one or more embodiments.

FIG. 9 illustrates an apparatus for detecting an anomaly in an image according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Parts that are irrelevant to the description will be omitted to clearly describe the present disclosure, and the same elements will be designated by the same reference numerals throughout the specification.

As used herein, each of the phrases “A or B”, “at least one of A and B”, “at least one of A or B,” “A, B or C,” “at least one of A, B, and C,” and “at least one of A, B, or C” may include all possible combinations of the items listed together in the corresponding one of the phrases.

Unless explicitly described to the contrary, the word “comprise”, and variations such as “comprises” or “comprising”, will be understood to imply the inclusion of stated elements but not the exclusion of any other elements.

In the present specification, an expression recited in the singular may be construed as singular or plural unless the expression “one”, “single”, etc. is used.

“And/or” includes all combinations of each and at least one of the constituent elements mentioned.

Terms including ordinal numbers such as first, second, and the like will be used only to describe various components, and are not to be interpreted as limiting these components. The terms are only used to differentiate one component from other components. For example, while not digressing from the claims according to the present disclosure, a first constituent element may be called a second constituent element, and similarly, the second constituent element may be called the first constituent element.

In the flowcharts described with reference to the drawings in this specification, the operation order may be changed, various operations may be merged, certain operations may be divided, and certain operations may not be performed.

An Artificial Intelligence (AI) model a machine learning model for learning at least one task, which may be implemented by/as a computer program (instructions) executed by a processor. The task learned by the AI model is a task to be solved through machine learning, or is a task to be performed through machine learning. The AI model may be implemented by/as a computer program (instructions) executed on a computing device, which may be downloaded through a network, sold as a product, etc. Alternatively, the AI model may interact with a variety of devices through a network.

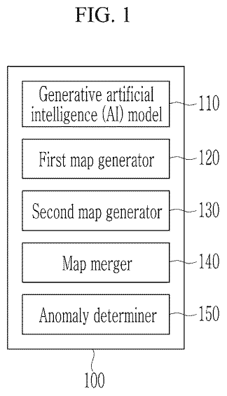

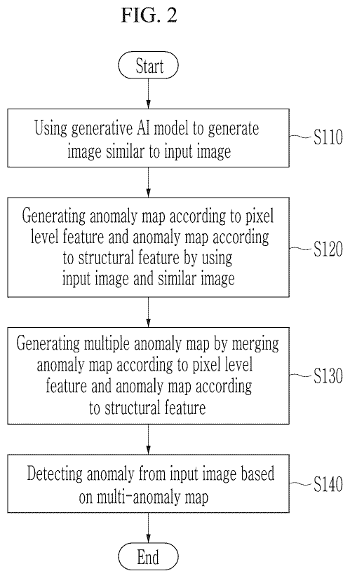

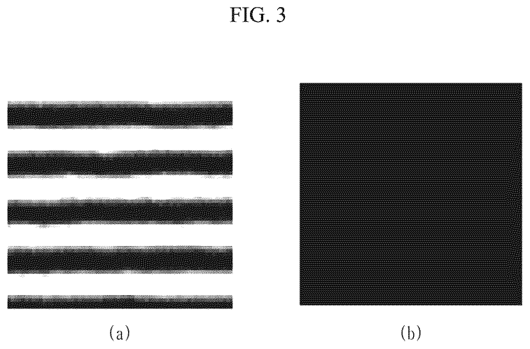

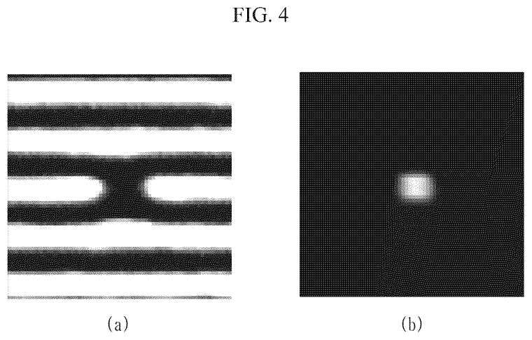

FIG. 1 illustrates an apparatus for detecting an anomaly in an image according to one or more embodiments. FIG. 2 illustrates a method for detecting an anomaly in an image according to one or more embodiments. FIG. 3 illustrates an example of a normal image and a an example of a multi-anomaly map of the normal image according to one or more embodiments. FIG. 4 illustrates an abnormal image and a multi-anomaly map of the abnormal image according to one or more embodiments.

An apparatus 100 for detecting an anomaly according to one or more embodiments may detect an anomaly in an input image by (i) generating a normal image that is most (or sufficiently) similar to the input image and (ii) generating an anomaly map based on a difference between the input image and the normal image. The input image may be any of a variety of images generated in a semiconductor manufacturing field, a medical field, an image surveillance field, a big data field, an industry field, etc. For example, the apparatus 100 may detect anomalies in medical images acquired by an examination equipment such as a patient's lesion image, computed tomography (CT), or magnetic resonance imaging (MRI), ultrasound, x-ray, and so forth. In some embodiments, the apparatus 100 may detect anomalies in images of wafers, etc., acquired by an inspection equipment in a semiconductor manufacturing process. In the case of semiconductor manufacturing, for example, the input image may be from a variety of different imaging equipment (e.g., infrared sensor, photo sensor, x-ray sensor, electron microscope, hyperspectral sensor, etc.). It will be appreciated that the embodiments and techniques described herein are applicable to images of any sensor type and of any subject.

Referring to FIG. 1, the apparatus 100 for detecting an anomaly may include a generative artificial intelligence (AI) model 110, a first map generator 120, a second map generator 130, a map merger 140, and an anomaly determiner 150. Some or all of these components in FIG. 1 may be implemented as corresponding units of processor-executable instructions, however, the divisions thereof, as indicated in FIG. 1, can vary, and it will be appreciated that the features and functions described herein may be arranged in other ways. Moreover, terms such as “generator”, “determiner”, “merger”, and the like may be shorthand terms for “generator code”, “determiner code”, “merger code”, and so forth, which refers to code (instructions) that perform the corresponding function.

In some embodiments, the generative AI model 110 may include an encoder and a decoder (e.g., of the neural network type), and the generative AI model 110 may be trained to generate images similar to respective input images by using the encoder and the decoder. For example, the generative AI model 110 may be an Al model such as an auto encoder (AE), a generative adversarial network (GAN), etc. In such an embodiment, the generative AI model 110 may be trained to generate a normal image (one without a defect therein) that is similar to the input image and the training based on input images labeled as normal (e.g., trained only with images labeled as normal/non-defect). In some implementations, the generated normal image may be one that is most similar to the corresponding input image from which it is inferred.

Referring to FIG. 2, by using the generative AI model 110, the normal image (e.g., one most/highly similar to the input image) may be generated (S110). The first map generator may generate an anomaly map related to the pixel-level features of the input image, and the anomaly map may be generated based on the input image and the normal image (which is similar to the input image). The second map generator 130 may generate an anomaly map related to structural features in image data of the input image and may do so based on the input image and the normal image (S120).

In some embodiments, the first map generator 120 may generate the anomaly map Sₚᵢₓₑₗ related to the pixel-level features as shown in Equation 1 below.

$${S}_{pixel} ( x ) = \vert x - f ( x ) \vert \qquad Equation 1$$

In Equation 1, x represents the input image, and f(x) represents the normal image similar to the input image (as output from the generative AI model 110). Referring to Equation 1, the differences between pixels of the input image x and the corresponding pixels of the normal image f(x) may be pixel values of the anomaly map related to the pixel-level feature.

The second map generator 130 may generate an anomaly map S_{structural} related to the structural features as shown in Equation 2 below.

$${S}_{s t r u c t u ral} ( x ) = 1 - SSIM ( x , f ( x ) ) \qquad Equation 2$$

In Equation 2, x represents the input image and f(x) represents the normal image similar to the input image output from the generative AI model 110. The anomaly map related to the structural feature may be generated by a structural similarity index (SSIM), as a non-limiting example of a similarity function. The larger the SSIM computed between the input image and the normal image similar to the input image, the more similar the structural pattern of the two images. The computed SSIM value may be a real number (e.g., a float point number) between 0 and 1. The SSIM may calculate the structural similarity between the input image and the normal image in predetermined patch units. Equation 3 shows a method for calculating the SSIM.

$$S S I M ( x , y ) = \frac{( 2 {μ}_{x} {μ}_{y} + {c}_{1} ) ( 2 {σ}_{x y} + {c}_{2} )}{( {μ}_{x}^{2} + {μ}_{y}^{2} + {c}_{1} ) ( {σ}_{x}^{2} + {σ}_{y}^{2} + {c}_{2} )} \qquad Equation 3$$

In Equation 3, μₓ is an average (a mean) of the pixel value of the image x and μ_{y} is the average of the pixel value of the image y. σₓ² is a variance of the image x, σ_{y}² is a variance of the image y, and σ_{xy} is a covariance of the image x and image y. As can be seen, similarity of the input image and normal/similar image may be a ratio of the product of the average pixel of each image (possibly weighted by the their covariance) to the sum of the squares of the respective means (possibly weighted by their respective variances). Although SSIM is practical, any method of calculating structural similarity between the input image and the normal/similar image may be used (i.e., computing interdependencies of spatially-close pixels). c₁ and c₂ are variables to stabilize the division of Equation 3 and may be determined by k and L as shown in Equation 4 below.

$$\begin{matrix}{c}_{1} = {( {k}_{1} L )}^{2} \\ {c}_{2} = {( {k}_{2} L )}^{2}\end{matrix} \qquad Equation 4$$

In Equation 4, a dynamic range for the pixel value may generally be determined as 2^{#bits per pixel}−1. In such an embodiment, k₁ may be predetermined to be 0.01 and k₂ may be predetermined to be 0.03.

In some embodiments, the second map generator 130 may calculate patch similarity between the input image and the normal image by moving patches of a predetermined size in the input image and the normal image by a stride of a predetermined spacing.

The second map generator 130 may set the stride as one pixel, for example, to output the anomaly map related to the structural feature (the anomaly map may have the same size as the size of the input image). Alternatively, the second map generator 130 may perform padding of a predetermined size for the input image and the normal image according to the size of the patch so as to generate the anomaly map to have the size of the input image. The second map generator 130 may determine pixel values of the anomaly map based on the patch-wise similarity between the input image and the normal image.

Referring to FIG. 2, the map merger 140 may generate a multi-anomaly map by merging the anomaly map related to the pixel-level features and the anomaly map related to the structural features (S130).

In some embodiments, the map merger 140 may merge the anomaly map related to the pixel-level features and the anomaly map related to the structural features as shown in Equation 5 below.

$$S ( x ) = {S}_{Pixel} ( x ) ⊙ {S}_{Structural} ( x ) \qquad Equation 5$$

In Equation 5, the ⊙ operator represents a pixel-wise multiplication (or Hadamard product) between the pixel values of the anomaly maps. For example, when the sizes of the input image, the anomaly map related to the pixel-level features S_{Pixel}(x), and the anomaly map related to the structural features S_{Structural}(x) are all m×n pixels, the map merger 140 may merge the anomaly map related to the pixel-level features S_{Pixel}(x) and the anomaly map related to the structural features S_{Structural}(x) through a multiplication operation of the pixel values of m×n times. In such an embodiment, noise may be reduced in the multi-anomaly map by merging the anomaly map related to the pixel-level features and the anomaly map related to the structural features by the map merger 140.

Referring to FIG. 2, the anomaly determiner 150 may perform anomaly detection based on the multi-anomaly map to detect any anomalies in the input image. Referring to FIG. 3, a normal image (a) and a multi-anomaly map (b) of the normal image are shown. Referring to FIG. 4, an abnormal image (a) and the multi-anomaly map (b) of the abnormal image are shown.

In some embodiments, when the multi-anomaly map is a 1-channel map data, whether the input image has an anomaly may be revealed depending on the magnitude of the pixel value of the multi-anomaly map.

For example, when the multi-anomaly maps are expressed in gray scale, the dark area in the multi-anomaly map may represent the normal region of the input image. In such an embodiment, bright areas may represent abnormal regions of the input image (e.g., the area where the corresponding defect or failure occurred in the wafer image of the imaged semiconductor).

Alternatively, in the multi-anomaly map, a part with the relatively low pixel value may represent normal region of the input image, and a part with the relatively high pixel value may represent abnormal region of the input image. Alternatively, in the multi-anomaly map, a part where the pixel value is smaller than a reference value may represent normal region of the input image, and a part where the pixel value is greater than the reference value may represent abnormal region of the input image. A reference value for differentiating normal region from abnormal region may be determined by use of a validation set or a training Al model.

Alternatively, when the multi-anomaly map has multiple channels, the channels of the multi-anomaly map may be merged into a single channel through averaging operation, etc., so that the normal region and the abnormal region may be distinguished. Alternatively, among the channels in the multi-anomaly map, pixel values of the a channel may indicate normal region, and pixel values of a channel other than the first channel may indicate abnormal region. For example, when the multi-anomaly map has RGB channels, a region where the blue channel is prominent in the multi-anomaly map may represent the normal region of the input image, and a region where the red channel is prominent may represent the abnormal region of the input image.

As explained above, the apparatus 100 for detecting an anomaly in an image according to one or more embodiments may detect anomalies in the input image with high reliability by using (i) the multi-anomaly maps generated by merging the anomaly map related to the pixel-level features of the input image and using (ii) the anomaly map related to the structural features.

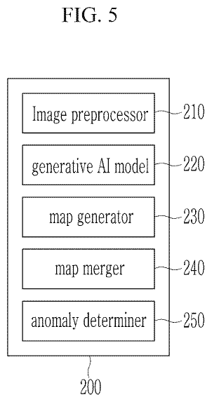

FIG. 5 illustrates an apparatus for detecting an anomaly in an image according to one or more embodiments.

Referring to FIG. 5, an apparatus 200 for detecting an anomaly according to some embodiments may include an image preprocessor 210, a generative AI model 220, a map generator 230, a map merger 240, and an anomaly determiner 250.

In some embodiments, the image preprocessor 210 may perform a preprocessing on an input image by considering features of the intended normal/similar image to be generated from the input image by the generative AI model 220. By performing the preprocessing on the input image to be transmitted to the generative AI model 220 and the map generator 230 by the image preprocessor 210, noise of the anomaly map related to the pixel-level features, the anomaly map related to the structural features, and the multi-anomaly map may be reduced.

For example, the image preprocessor 210 may perform the preprocessing on the input image as shown in Equation 6.

$${x}^{′} = {G}_{k , σ} ( x ) \qquad Equation 6$$

In Equation 6, G_{k,σ}(x) is a Gaussian filter that performs blurring on the input image, k represents a kernel size that performs the blurring, and σ represents a standard deviation of a Gaussian distribution of the Gaussian filter.

The generative AI model 220 of the apparatus 200 may generate a normal (non-defect) image similar to the pre-processed version of the input image (by the image preprocessor 210).

The map generator 230 of the apparatus 200 may generate the anomaly map related to the pixel-level features of the image and generate the anomaly map related to the structural features of the image based on the input image preprocessed by the image preprocessor 210 and based on the normal image corresponding to the preprocessed input image as generated by the generative AI model 220.

In some embodiments, the map generator 230 may generate the anomaly map related to the pixel-level features of the preprocessed input image according to Equation 1. Additionally, the map generator 230 may generate the anomaly map related to the structural features of the preprocessed input image according to Equation 2. In another embodiment, because the anomaly map is generated based on (i) the input image preprocessed through the Gaussian filter, etc. and (ii) the normal image corresponding to the preprocessed input image, noise may be reduced in respective anomaly maps generated by the map generator 230.

The map merger 240 of the apparatus 200 according to another embodiment may generate multi-anomaly maps by merging the anomaly map related to the pixel-level features of the preprocessed input image and the anomaly map related to the structural features of the preprocessed input image. The map merger 240 may merge the anomaly map based on the pixel-level features and the anomaly map based on the structural features, as shown in Equation 5.

In some embodiments, when the map merger 240 merges the anomaly map related to the pixel-level features of the preprocessed input image and the anomaly map related to the structural features of the preprocessed input image, noise included within the anomaly map (related to the pixel-level features) and noise within the anomaly map (related to the structural features) may be reduced once again. In other words, the noise level of the multi-anomaly map may be lower than the noise level of the anomaly map related to the pixel-level features or the anomaly map related to the structural features.

The anomaly determiner 250 of the apparatus 200 according to another embodiment may detect anomalies in the input image based on the multi-anomaly map. In such an embodiment, because the noise level of the multi-anomaly map is relatively very low, the anomaly determiner 250 may accurately determine the abnormal region(s) in the input image based on the multi-anomaly map.

As described above, the apparatus 200 for detecting an anomaly in an image may generate the anomaly map related to the pixel-level features and the anomaly map related to the structural features by using the preprocessed input image, and may use the multi-anomaly map generated by merging the anomaly map based on the pixel-level features and the anomaly map based on the structural features, thereby the anomalies may be detected in the input images with high reliability.

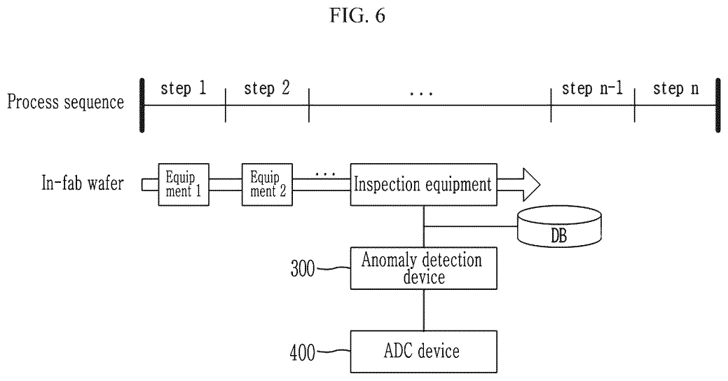

FIG. 6 illustrates a defect detection system of a semiconductor manufacturing process according to one or more embodiments.

In some embodiments, a measurement image may be generated by an inspection equipment during a semiconductor manufacturing process of an in-fab wafer, and most measurement images generated in a high yield environment may be images of normal (non-defective) wafers. When the types of defects are diverse and the number of defects is small, it may be difficult to train an anomaly detection model by using defective images, due to their low availability/quantity.

The anomaly detection device 300 of the defect detection system according to one or more embodiments may train the generative AI model to generate a normal image that is similar to an image labeled as being normal.

Referring to FIG. 6, among the measurement images of the product taken by the inspection equipment, the measurement images labeled as normal may be stored in a database DB for the training of the generative AI model of the anomaly detection device 300. Images may be captured at different respective steps and for different respective pieces of equipment

Afterwards, when an unlabeled image is received from the inspection equipment, the anomaly detection device 300 may generate a corresponding normal image that is similar to the input image by using the generative AI model, and generate the multi-anomaly map to detect the anomaly in the input image based on the input image and the normal image. Also, the anomaly detection device 300 may detect the anomaly in the input image by using the multi-anomaly map.

When an anomaly is detected in the input image, the anomaly detection device 300 may use the multi-anomaly map to determine a specific patch of the input image that includes the anomaly and transmit information about the patch to an automatic defect classification (ADC) device 400. The ADC device 400 may determine the type of the defect corresponding to the anomaly based on information about the input image and based on the patch that includes the anomaly, and thus performance of the entire defect detection system may be improved.

As explained above, the AI model may be trained through the normal images generated in the high yield environment, so that the detection of anomalies in new images may be performed with high reliability even in environments where the number of the defects is small and/or the types of defects are diverse.

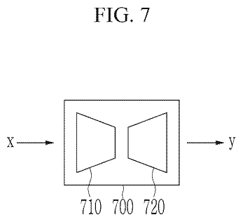

FIG. 7 illustrates an example of a generative AI model according to one or more embodiments.

Referring to FIG. 7, a generative AI model 700 may include an encoder 710 and a decoder 720. In such an embodiment, the encoder 710 and/or the decoder 720 may include a neural network including an input layer, at least one hidden layer, and an output layer.

In some embodiments, the encoder 710 of the generative AI model 700 may extract and encode features from an input image, and the decoder 720 may infer an image by decoding the encoded extracted features. The encoder 710 may map the input image to features of a latent space. In other words, the generative AI model 700 may perform an unsupervised learning that trains a low-dimensional feature representation from unlabeled input images.

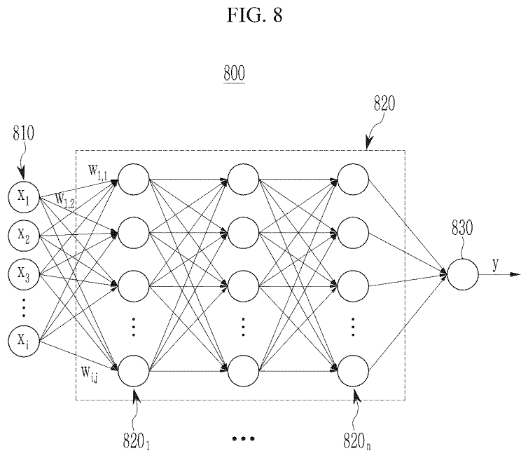

FIG. 8 illustrates a neural network according to one or more embodiments.

Referring to FIG. 8, a neural network 800 according to one or more embodiments may include an input layer 810, a hidden layer portion 820, and an output layer 830. The input layer 810, layers in the hidden layer portion 820, and the output layer 830 may include respective sets of nodes, and the strengths of the connections between the nodes of layers (generally, adjacent, but not necessarily) may be represented as weights (weighted connections). The nodes included in the input layer 810, the layers in the hidden layer portion 820, and the output layer 830 may be fully connected to each other, although other architectures may be used. In some embodiments, the number of parameters (e.g., the number of weights and the number of biases) may be equal to the number of weighted connections in the neural network 800.

The input layer 810 may include input nodes x₁ to xᵢ, and the number of input nodes x₁ to xi may correspond to the number of independent variables of the input data. A training set may be input to the input layer 810 for training of the neural network 800. When test data is input to the input layer 810 of the trained neural network 800, an inference result may be output from the output layer 830 of the trained neural network 800. In some embodiments, the input layer 810 may have a structure suitable for processing a large-scale input. In a non-limiting example, the neural network 800 may include a convolutional neural network combined with fully connected layer(s).

The layers of the hidden layer portion 820 may be located between the input layer 810 and the output layer 830 and may include at least one of hidden layers 8201 to 820n. The output layer 830 may include a node y. An activation function may be used in the layers of the hidden layer portion 820 and in the output layer 830. In some embodiments, the neural network 800 may be learned by adjusting weight of the nodes included in the hidden layer portion 820.

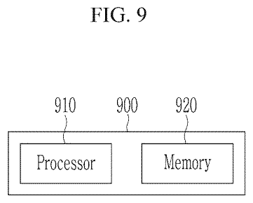

FIG. 9 illustrates an apparatus for detecting an anomaly in an image according to one or more embodiments.

An apparatus for detecting an anomaly in an image according to one or more embodiments may be implemented as a computer system.

Referring to FIG. 9, the computer system 900 may include one or more processors 910 and a memory 920. The memory 920 may be connected to the one or more processors 910 and may store instructions configured to cause the one or more processors 910 to perform a process including any of the methods described above.

The one or more processors 910 may realize functions, stages, or methods described for the various embodiments. An operation of the computer system 900 according to one or more embodiments may be realized by the one or more processors 910. The one or more processors 910 may include a GPU, a CPU, and/or an NPU. When the operation of the computer system 900 is implemented by the one or more processors 910, each task may be divided among the one or more processors 910 according to load. For example, when one processor is a CPU, the other processors may be a GPU, an NPU, an FPGA, and/or a DSP.

The memory 920 may be provided inside/outside the processor, and may be connected to the processor through various means known to a person skilled in the art. The memory may be a volatile or non-volatile storage medium in various forms (but not a signal per se), and for example, the memory may include a read-only memory (ROM) and a random-access memory (RAM). In another way, the memory may be a PIM (processing in memory) including a logic unit for performing self-contained operations (e.g., bit cells may function as both persistent bit storage and may have circuit elements for also performing operations on the stored bit data).

In another way, some functions (e.g., training the yield predicting model and/or the path generating model, inference by the yield predicting model and/or the path generating model) of the yield predicting device may be provided by a neuromorphic chip including neurons, synapses, and inter-neuron connection modules. The neuromorphic chip is a computer device simulating biological neural system structures, and may perform neural network operations.

Meanwhile, the embodiments are not only implemented through the device and/or the method described so far, but may also be implemented through a program (instructions) that realizes the function corresponding to the configuration of the embodiment or a recording medium on which the program is recorded, and such implementation may be easily implemented by anyone skilled in the art to which this description belongs from the description provided above. Specifically, methods (e.g., yield predicting methods, etc.) according to the present disclosure may be implemented in the form of program instructions that can be performed through various computer means. The computer readable medium may include program instructions, data files, data structures, etc. alone or in combination. The program instructions recorded on the computer readable medium may be specifically designed and configured for the embodiments. The computer readable recording medium may include a hardware device configured to store and execute program instructions. For example, a computer-readable recording medium includes magnetic media such as hard disks, floppy disks and magnetic tapes, optical recording media such as CD-ROMs and DVDs, and optical disks such as floppy disks. It may be magneto-optical media, ROM, RAM, flash memory, or the like. A program instruction may include not only machine language codes such as generated by a compiler, but also high-level language codes that may be executed by a computer through an interpreter or the like.

While some of the description herein includes mathematical notation and equations, the mathematical notation is a shorthand substitute for equivalent textual description. An engineer or the like may, based on the mathematical notation (and other description), craft source code analogous to the mathematical notation (e.g., source code that implements the mathematical equations), and such source code may be compiled into processor-executable instructions that are analogous to, and implement, the mathematical equations.

Although the description above involves images of semiconductor wafers, the methods and systems are not limited thereto. The techniques may be used for images of any suitable subject matter.

The computing apparatuses, the electronic devices, the processors, the memories, the displays, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for detecting an anomaly in an input image, the method performed by one or more processors and comprising:
generating a first anomaly map of pixel-level features of an input image and a second anomaly map of structural features of the input image, the generating based on the input image and based on a first non-defect image corresponding to the input image;
generating a multi-anomaly map by merging the first anomaly map and the second anomaly map; and
detecting the anomaly in the input image based on the multi-anomaly map.

2. The method of claim 1, further comprising:
generating the first non-defect image from the input image by using a generative artificial intelligence (AI) model.

3. The method of claim 1, further comprising:
performing a preprocessing on the input image to generate a preprocessed input image; and
generating a second non-defect image similar to the preprocessed input image by using a generative artificial intelligence (AI) model.

4. The method of claim 3, wherein;
the generating the first anomaly map of pixel-level features of the input image and the second anomaly map of structural features of the input image based on the input image and based on the non-defect image corresponding to the input image comprises
generating the first anomaly map and the second anomaly map based on the preprocessed input image and the second non-defect image corresponding to the preprocessed input image.

5. The method of claim 1, wherein:
the generating the first anomaly map of pixel-level features of the input image and the second anomaly map of structural features of the input image based on the input image and the non-defect image corresponding to the input image comprises
generating the first anomaly map based on a difference between a first pixel of the input image and a second pixel of the non-defect image,
wherein the second pixel corresponds to the first pixel.

6. The method of claim 1, wherein:
the generating the first anomaly map of the pixel-level features of the input image and the second anomaly map of the structural features of the input image based on the input image and the non-defect image corresponding to the input image comprises
calculating a patch similarity between a patch of a predetermined size in the input image and a corresponding patch in the non-defect image; and
generating the second anomaly map based on the patch similarity.

7. The method of claim 6, wherein the patch similarity is calculated by performing padding on the input image and the non-defect image and moving the patch by a stride of a predetermined spacing.

8. The method of claim 1, wherein:
the merging the first anomaly map and the second anomaly map comprises multiplying pixel values of pixels of the first anomaly map with pixel values of respectively corresponding pixels in the second anomaly map.

9. The method of claim 1, wherein:
the detecting the anomaly in the input image based on the multi-anomaly map comprises
detecting a non-defect region and/or abnormal region in the input image based on a condition related to pixel values of the multi-anomaly map.

10. The method of claim 9, further comprising:
determining a defective patch within the input image by using the multi-anomaly map in response to the anomaly being detected in the input image; and
transmitting information about the defective patch to a defect classification system.

11. An apparatus for detecting an anomaly in an image, the apparatus comprising:
one or more processors and a memory, wherein the memory stores instructions configured to cause the one or more processors to perform a process including:
generating a first anomaly map related to pixel-level features of the input image based on the input image and a non-defect image corresponding to the input image;
generating a second anomaly map related to structural features of the input image based on the input image and the non-defect image;
generating a multi-anomaly map by merging the first anomaly map and the second anomaly map; and
detecting the anomaly in the input image based on the multi-anomaly map.

12. The apparatus of claim 11, wherein:
the process further including:
generating a preprocessed input image by preprocessing on the input image; and
generating the non-defect image similar to the preprocessed input image by using a generative artificial intelligence (AI) model.

13. The apparatus of claim 12, wherein:
the generating the first anomaly map related to the pixel-level features of the input image comprises
generating the first anomaly map based on differences between first pixels of the input image and second pixels of the non-defect image, wherein positions of respective second pixels corresponds to the positions of respective first pixels.

14. The apparatus of claim 11, wherein:
the generating the second anomaly map related to the structural features of the input image comprises:
calculating patch similarity between the input image and the non-defect image for a patch having a predetermined size in the input image; and
generating the second anomaly map based on the patch similarity between the input image and the non-defect image.

15. The apparatus of claim 14, wherein:
the calculating the patch similarity between the input image and the non-defect image comprises
performing padding on the input image and the non-defect image; and
calculating the patch similarity by moving the patch by a stride of a predetermined spacing.

16. The apparatus of claim 11, wherein:
the generating the multi-anomaly map by merging the first anomaly map and the second anomaly map comprises
generating the multi-anomaly map by multiplying pixel values of corresponding pixels between the first anomaly map and the second anomaly map.

17. A system for detecting a defect in a semiconductor manufacturing process, the system comprising:
an anomaly detection device configured to generate a multi-anomaly map based on an unlabeled input image transmitted from inspection equipment of the semiconductor manufacturing process and a non-defect image similar to the input image, and detect an anomaly in the input image based on the multi-anomaly map; and
a defect classification device configured to determine a type of the defect corresponding to the anomaly of the input image.

18. The defect detection system of claim 17, wherein:
when detecting the anomaly in the input image based on the multi-anomaly map, the anomaly detection device further configured to use the multi-anomaly map to determine a patch including the anomaly and transmit information about the patch to the defect classification device.

19. The defect detection system of claim 17, wherein:
when generating the multi-anomaly map based on the input image and the non-defect image, the anomaly detection device further configured to merge a first anomaly map related to pixel-level features of the input image and a second anomaly map related to structural features of the input image to generate the multi-anomaly map.

20. The defect detection system of claim 19, wherein:
the anomaly detection device further configured to generate the first anomaly map based on differences between first pixels of the input image and second pixels of the non-defect image and generate the second anomaly map based on similarity of patches between the input image and the non-defect image.
